(19) United States
(12) Patent Application Publication
(10) Pub. No.: US 2019/0296788 A1
(43) Pub. Date: Sep. 26, 2019

(54) PROTECTIVE CASE FOR ELECTRONIC DEVICE WITH DUAL PURPOSE STORAGE AND STAND ATTACHMENT

(71) Applicant: Cesar Zavala, Fontana, CA (US)

(72) Inventor: Cesar Zavala, Fontana, CA (US)

(21) Appl. No.: 16/435,489

(22) Filed: Jun. 8, 2019

Related U.S. Application Data
(63) Continuation of application No. 15/701,753, filed on Sep. 12, 2017, now abandoned.
Application No. 15/701,753 is a continuation-in-part of application No. 14/707,113, filed on May 8, 2015, now abandoned.

(51) Int. Cl. H04B 1/3888; A45C 11/00; A45C 11/32; A45C 1/08

(52) U.S. Cl. CPC H04B 1/3888; A45C 11/00; A45C 11/321; A45C 2001/083; A45C 2001/086; A45C 2011/003; A45C 2011/002; A45C 1/08

(57) ABSTRACT

A protective case comprising; a housing having a front compartment and a rear surface, wherein the front compartment is sized to securely fit an electronic device; a first plurality of attachment points secured to the rear surface of the housing; a first plurality of securing means secured to the piece of elastic material; and a detachable compartment having—a front surface and a rear surface, wherein an opening to a compartment is formed between the front and rear surfaces and the compartment is accessible through an opening, a second plurality of attachment points are secured to the rear surface, wherein the second plurality of attachment points substantially align with the first plurality of attachment points, and a second plurality of securing means, wherein the second plurality of securing means substantially align with the first plurality of securing means.

### CROSS-REFERENCE TO RELATED APPLICATIONS

This application is a continuation of U.S. application Ser. No. 15/701,753 filed Sep. 12, 2017. The disclosure of the prior applications is considered part of (and is incorporated by reference in) the disclosure of this application.

### BACKGROUND

The present invention relates generally to the field of protective cases, and more particularly to a protective cover for an electronic device that has a stretchable storage area.

With portable handheld electronic devices (smart phones, media players, and other small personal electronic devices) becoming immensely popular and the expensive of these devices increasing rapidly. The owners of these devices want to protect them, through the use of protective cases. Many different types of cases have been designed and created to provide the owner with varying degrees of protection and convenience.

One problem the prior art references have attempted to solve is the incorporation of a wallet or pocket in the case. If one wanted to carry their phone and their wallet they would need two different items. This increases the number of such items a person carries around, the greater the likelihood that she will either forget one or more of the items at home, and the greater the likelihood that she will misplace one in a restaurant, bar, office, etc. Some prior art cases combine a portable handheld electronic device protection capability with the personal-item-carrying capability of a wallet.

The issue with these prior art invention is that such prior art offering compartments for carrying personal items are often too bulky to fit easily in a users' pocket. Some prior art cases have rigid compartments integrated into the case, reducing the items which can physically fit within the compartment. Other prior art cases try to allow for larger items to be attached to the phone but they are difficult to use and not secure which results in the person losing their items or having to fumble around with the phone.

Thus, it is desired to have a protective case that has a compartment that is secure, can fit numerous items of varying thickness and shape and be aesthetically pleasing.

### SUMMARY

According to one aspect of the present invention, a multipurpose protective case for electronic devices comprising; a housing having a front compartment and a rear surface, wherein the front compartment is sized to securely fit an electronic device; a piece of elastic material secured to the rear surface of the housing, wherein an accessible space is formed between the rear surface of the housing and the piece of elastic material; a first plurality of attachment points secured to the rear surface of the housing; a first plurality of securing means secured to the piece of elastic material; and a detachable compartment having-a front surface and a rear surface, wherein an opening to a compartment is formed between the front and rear surfaces and the compartment is accessible through an opening, a second plurality of attachment points are secured to the rear surface, wherein the second plurality of attachment points substantially align with the first plurality of attachment points, and a second plurality of securing means, wherein the second plurality of securing means substantially align with the first plurality of securing means.

According to another aspect of the present invention, a protective case for electronic devices comprising; a housing sized to secure to an electronic device and having a rear surface; a first plurality of attachment points secured to the rear surface of the housing at predetermined locations; a first plurality of securing means secured to the piece of elastic material positioned relative to the first plurality of attachment points; and a detachable compartment having a rear surface, wherein a second plurality of attachment points secured to the rear surface and a second plurality of securing means secured to the rear surface in substantially the same position as the first plurality of the attachment points and the securing means.

### BRIEF DESCRIPTION OF THE SEVERAL VIEWS OF THE DRAWINGS

FIG. 1 depicts a perspective view of a protective case, in accordance with one embodiment of the present invention.

FIG. 2 depicts an exploded view of the protective case and the attachable storage compartment, in accordance with an embodiment of the present invention.

FIG. 3 depicts a rear view of the attachable storage compartment, in accordance with an embodiment of the present invention.

FIG. 4 depicts a front view of the protective case, in accordance with an embodiment of the present invention.

FIG. 5 depicts a perspective view of the attachable storage compartment used as a stand, in accordance with an embodiment of the present invention.

FIG. 6 depicts a perspective view of the attachable storage compartment used as a stand, in accordance with another embodiment of the present invention.

FIG. 7 depicts a front view of the protective case, in accordance with another embodiment of the present invention.

### DETAILED DESCRIPTION

The present invention relates to a protective case that has an attachable compartment that connects to the rear side of the protective case. The attachable compartment is made of a stretchable and flexible material to allow for larger items to be stored in the compartment. It also allows the user to carry a single item that has their electronic device (e.g. phone) and their other belongings (e.g. credit cards, money, phone keys, etc.) and frees up valuable pocket or purse space. The attachable compartment allows for a greater variety of items which can be help, and the ability to attach and detach the compartment allows the user more freedom to work with. The attachable compartment also, based on the fastening mechanisms, can be used as a stand for the electronic device in various positions.

The design shown below and, in the figures, provides a protective case that has an attachable compartment that also acts as a stand when fastened to the protective case in specific setups. This provides the user with the opportunity to have additional storage attached to the protective device that is easily detachable and also provides a stand for their protective case when needed.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein may also be used in the practice or testing of the present invention, the preferred methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

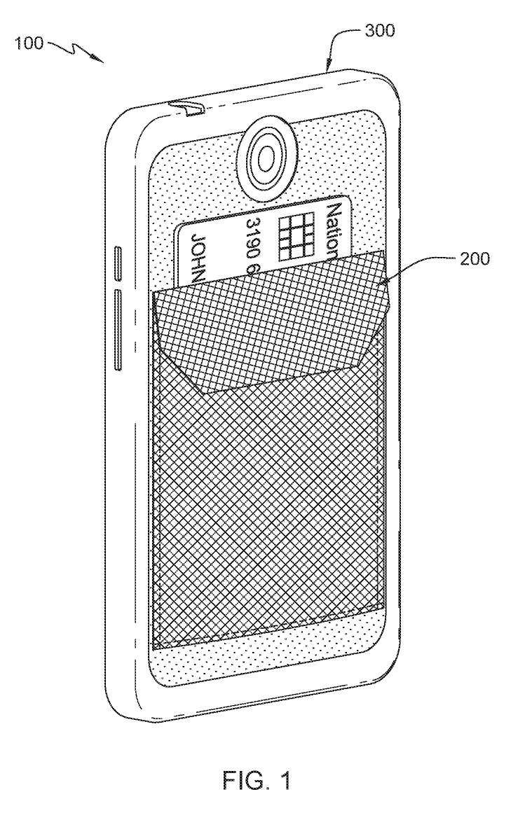

FIG. 1 depicts a perspective view of an electronic device case and storage assembly 100, in accordance with one embodiment of the present invention. In the depicted embodiment, the electronic device case and storage assembly 100 is comprised of an attachable storage 200 and a protective case 300. The attachable storage 200 is secured to the rear surface of the protective case 300 to allow full access to the electronic device (not shown). The protective case 300, has various openings or apertures for various features and functions of the phone (e.g. camera, microphone, buttons, etc.). In the depicted embodiment, the protective case 300 is shown with an opening for a camera on the rear side of the electronic device. In some embodiments, there may be additional removable cover for these features and functions. For example, the camera may have a cover that is removable or detachable. In the depicted embodiment, the attachable storage 200 is positioned on the protective case 300 not to interfere with these openings or apertures of the protective case 300.

The protective case 300 is sized and shaped to fit the various electronic device(s) it is designed to securely fit and protect. The depicted embodiment is one shape and size, but many shapes and sizes may be required based on the type of electronic device.

The attachable storage 200 provides a compartment to store various items. The depicted embodiment is only one style of compartments which the attachable storage 200 can embody. Various sizes, shapes, textures, materials, or the like can be used based on both the intended items to be held within the compartment, and the size and shape of the protective case 300. In some embodiments, the attachable storage 200 is made from a waterproof material and has a substantially waterproof closing mechanism. The attachable storage 200 may come in various sizes, shapes, colors, designs, and the like. For example, one attachable storage 200 may be sized to fit credit cards only. In another example, the attachable storage 200 may be sized to fit a key for an automobile (either keyed or keyless entry) and various other oversized items.

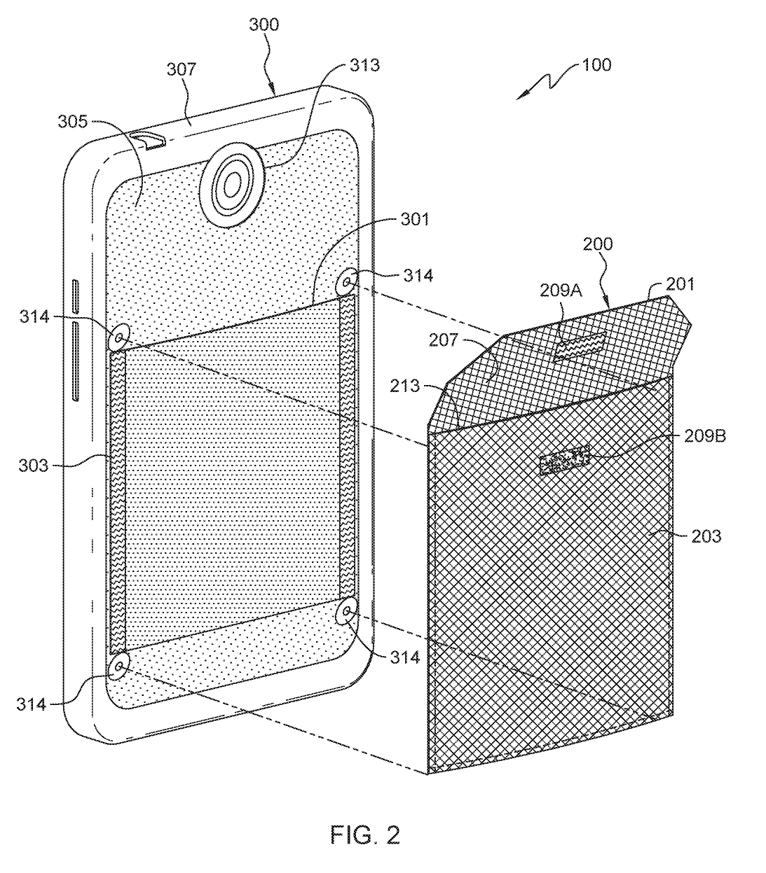

FIG. 2 depicts an exploded view of the electronic device case and storage assembly 100, in accordance with an embodiment of the present invention. In the depicted embodiment, the protective case 300 is comprised of an edge guard 307 covering substantially the edge of the electronic device and a back cover 305, which covers the rear surface of the electronic device. The edge guard 307 covers a predetermined surface area of the electronic device, while the back cover 305 covers the remaining exposed surface area of the electronic device on its' rear side. The edge guard 307 and the back cover 305 create a substantially watertight bond between one another. In some embodiments, the edge guard 307 is a single element covers substantially the same space as the edge guard 307 and the back cover 305 combined. Based on the electronic device the protective case 300 has a predetermined shape designed to securely fit to the electronic device, with predetermined openings and apertures to allow access to the screen, keypad, camera, charging ports, and other inputs (e.g. opening 313 is shown for the camera).

The edge guard 307 may be made from, but not limited to, aluminum, steel, iron, copper, brass, bronze, zinc, stainless steel, polyolefins, styrenics, polypropylene, copolymer polypropylene, polystyrene, thermoplastic elastomers, thermoplastic elastomers, polyethylene, polypropylene, polystyrene, copolymer polypropylene, or the like that are able to be fitted around the electronic device, but also provide protection to the electronic device if dropped or hit against a hard surface. The back cover 305 is made from an elastic material such as various polymers, natural rubber, synthetic rubber, silicone rubber, ethylene vinyl acetate rubber, Spandex®, nylon, stretch vinyl and the like. In some embodiments, the sleeve 301 and the back cover 305 are made from the same material and are a unitary element. In some embodiments, the back cover 305 is made from a rigid, or semi-elastic material.

On the rear surface of the protective case 300, a sleeve 301 is secured to the back cover 305 and along the exposed edges of the sleeve 301 a plurality of first fastener segment 303 are secured. In the depicted embodiment, the first fastener segment 303 covering substantially two sides of the sleeve 301 and a lower edge is securely attached to the back cover 305, thereby creating an accessible compartment between the rear surface of the protective case and the sleeve 301 which can receive and store various items (show in FIG. 1 where the card is partially extending out of the compartment formed by sleeve 301). In additional embodiments, the first fastener segment 303 is along the only the two vertical sides of the sleeve 301. In additional embodiments, the bottom side of the sleeve 301 is exposed and the first fastener segment 303 is secured to the back cover 305 below the bottom of the sleeve 301. The first fastener segment 303 may be, but not limited to a hook and loop style fastener or various other detachable fasteners known to those skilled in the art.

The sleeve 301 may be made from, but not limited to, an elastic material such as various polymers, natural rubber, synthetic rubber, silicone rubber, ethylene vinyl acetate rubber, Spandex®, nylon, stretch vinyl and the like.

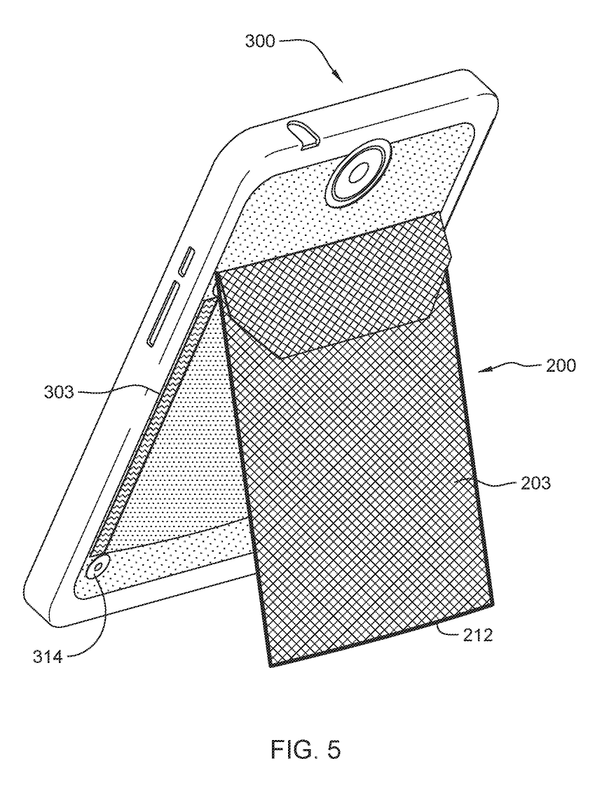

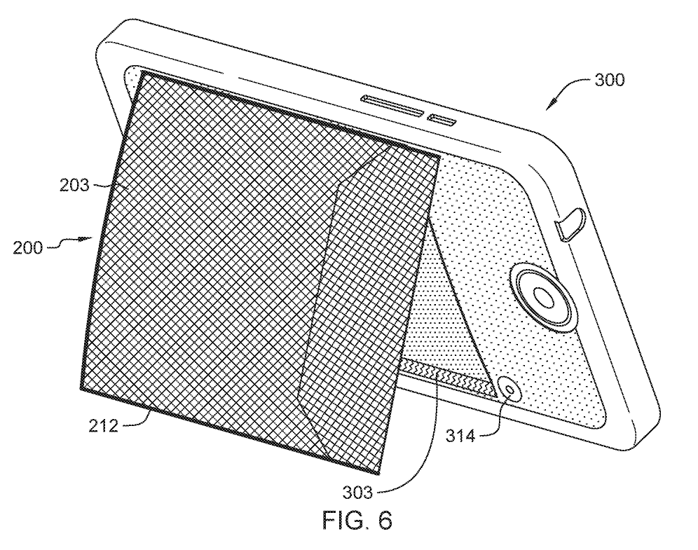

A securing mechanism 306, in the depicted embodiment, is attached at the four corners of the sleeve 301. These first attachment point 314 provide a detachable securing means, which are connected to reciprocal securing means (not shown) on the attachable storage 200. In the depicted embodiment, the first attachment point 314 are magnets. However, in various embodiments various fasteners can be used. These first attachment point 314 provide for the attachable storage 200 to be connected to the protective case 300 at any one of the corners and prop the protective case up (as shown in FIGS. 5 and 6).

The attachable storage 200 is shown having a main body with an opening to an internal compartment at the top end 205, and a flap 201 that covers the opening at the top end 205. In the shown embodiment, the three sides of the man body expect for the top end 205 are substantially secured and closed. In the depicted embodiment the attachable storage 200 is a unitary piece of material. In additional embodiments, the attachable storage 200 is comprised of a plurality of different pieces of material secured together. In various embodiments, the attachable storage 200 is comprised of several layers of material.

On surface 207 of the flap 201 a first attachment means 209A is secured in a predetermined location and a second attachment means 209B is secured to rear surface 203 in a position that substantially aligns with the first attachment means 209A, so that when the flap 201 is closed, the first and second attachment means 209A and 209B mate. The attachable storage 200 is sized to substantially cover the sleeve 301 of the protective case 300, wherein the first fastener segment 303 substantially aligns with a securing means (not shown) of the attachable storage 200 to secure the two together. The flap 201 is sized to cover a predetermined portion of the opening so that materials placed inside, they secured within the internal compartment. Opening 213 may have various other securing means such as zippers, latches, and the like. In some embodiments, these other securing means provide a watertight seal of the internal compartment of the attachable storage 200.

The first and second attachment means 209A and 209B are mating materials, such as, but not limited to a hook and loop style fastener or various other detachable fasteners known to those skilled in the art. The attachable storage 200 may be made from, but not limited to, an elastic material such as various polymers, natural rubber, synthetic rubber, silicone rubber, ethylene vinyl acetate rubber, Spandex®, nylon, stretch vinyl and the like.

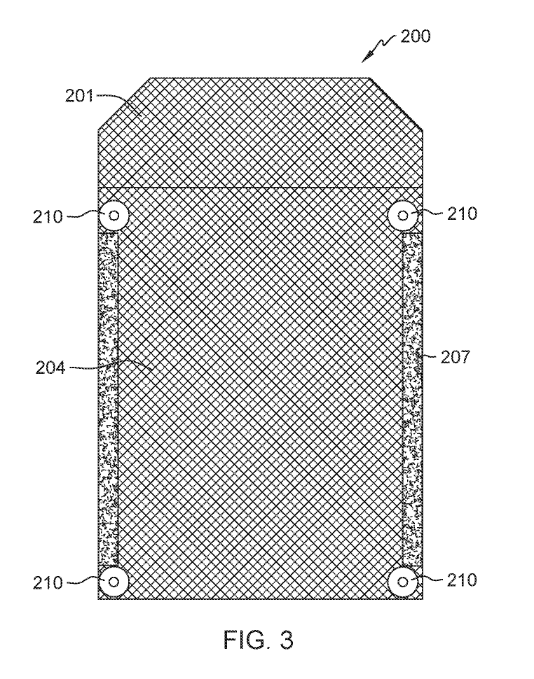

FIG. 3 depicts a rear view of the attachable storage 200 in the open position, in accordance with an embodiment of the present invention. The attachable storage 200 is designed to flex to accommodate items to fit within the internal compartment, while permitting the attachment points and the fastener segments to engage with the housing 300.

The rigidity of the attachable storage 200 may be accomplished by a layer of rigid material being integrated into surface 204. In some embodiments, a second fastener segments 207 may have a rigid design. This will allow the attachable storage 200 to flex to accommodate various items placed within the compartment and still be used as a stand to support the housing 300. The rigid material may be integrated into the single piece of material design.

The second fastener segment 207 and the second attachment points 210 are shown on the surface 203 of the attachable storage 200. In the depicted embodiment, the second fastener segment 207 is shown along the edges of the rear surface 203, and this is designed to substantially align with the first fastener segment 303 of the protective case 300. The second attachment point 210 are shown attached to rear surface 203 of the attachable storage 200. The second attachment point 210 substantially align with the first attachment point 314 of the protective case. The second attachment point 210 are designed to mate with the fastening type of the first attachment point 314. The attachable storage 200 is able to attach to the housing 300 in various positions and directions based on the spacing and positioning the of the attachment points and the fastener segments. For exemplary purposes the attachable storage 200 may be able to attach right side up (shown in FIG. 5) or upside down as the placement of the attachment points and the fastener segments are symmetrical.

In additional embodiments, the second fastener segment 207 may have different configurations or placements based on the first fastener segment 303 location and placement. The second fastener segment 207 is shown terminating substantially at the interchange of the top edge and the flap 201. The second fastener segment 207 may be, but not limited to a hook and loop style fastener or various other detachable fasteners known to those skilled in the art.

The attachable storage 200 may be made from, but not limited to, an elastic material such as various polymers, natural rubber, synthetic rubber, silicone rubber, ethylene vinyl acetate rubber, Spandex®, nylon, stretch vinyl and the like. In some embodiments, where the attachable storage 200 is made from, or a portion of the attachable storage 200 is made from a rigid material, various plastics, polymers, metals, or materials with increased rigidity may be incorporated into the design.

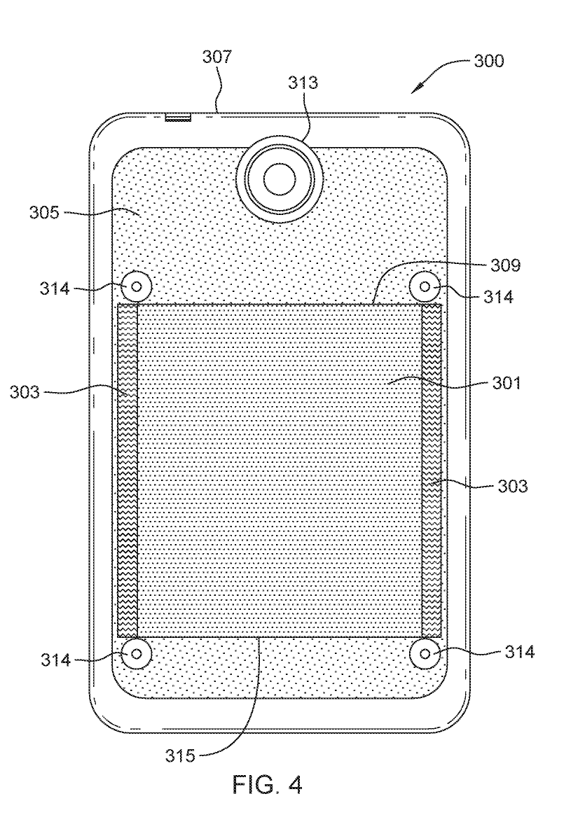

FIG. 4 depicts a rear view of housing 300, in accordance with an embodiment of the present invention. The fastener segments and the attachment points are shown substantially aligned. This allows for easy connecting of the attachable storage 200 to the housing 300.

FIG. 5 depicts a perspective view of the attachable storage compartment 200 used as a stand, in accordance with an embodiment of the present invention. The attachable storage compartment 200, is able to provide support for the protective case 300 in a “portrait” mode shown in the depicted embodiment. In the depicted embodiment, the attachable storage compartment 200 is attached at the top two attachment points, and the bottom attachment points are detachable. The attachable storage compartment 200, is able to extend away from the protective case 300 and prop the protective case 300 in an upwards position while the attachment means (314 and 210 respectively) remain fastened. The attachable storage compartment 200 has the structural rigidity to hold the housing 300 in position, even if items are stored within the attachable storage compartment 200. In the depicted embodiment, the bottom edge 211 of the attachable storage 200 has an anti-slip coating to assist in maintaining the desired position of the user. The housing 300, edge is also made of an anti-slip material. In some embodiments, the anti-slip coating is a rubber or material with a high friction coefficient that also seals the edges of the attachable storage 200.

FIG. 6 depicts a perspective view of the attachable storage compartment 200 used as a stand, in accordance with another embodiment of the present invention. The protective case 300 is rotated 90 degrees, and two of the attachment points are attached to provide a stand in a “landscape” mode. The anti-slip, or high friction coating 212 is applied to the edges of the attachable storage 200. The coating 212 may, in some embodiments, provide additional rigidity to the edges of the attachable storage 200 to further assist the attachable storage retain its shape when used as a stand, as shown. In additional embodiment, various edges of the attachable storage 200 have the anti-slip coating to allow for any position of the attachable storage 200 to remain in place when put into the “stand” position. The

In additional embodiments, various buttons, clasps, clips, and adhesive materials may be used to replace the various attachment means used in the electronic device case and storage assembly 100.

In a first embodiment, the sleeve 301 is sized to fit at least one credit card or other card, and the attachable storage 200 is sized to fit small items such as lip gloss, headphones, keys, or the like. In various embodiments, the size of the sleeve 301 and the attachable storage 200 may be altered or modified to hold larger items.

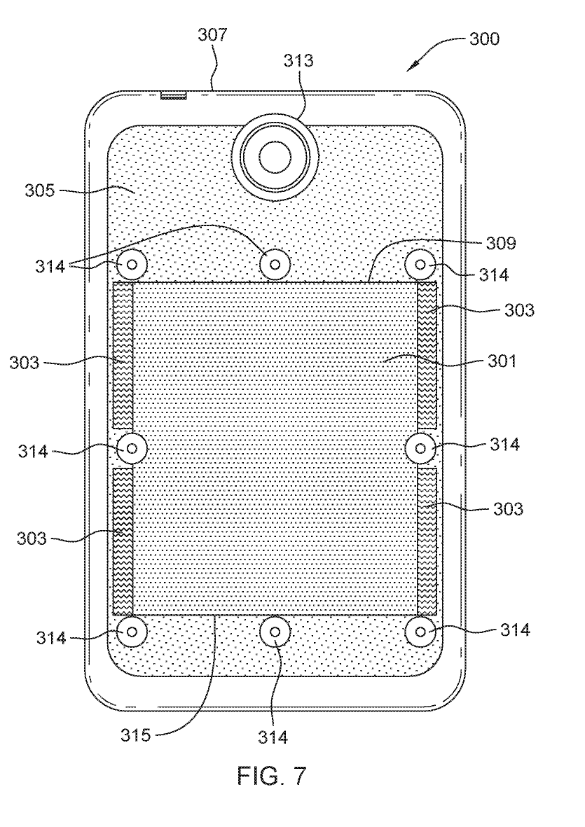

FIG. 7 depicts a front view of the protective case 300, in accordance with another embodiment of the present invention. In the depicted embodiment, the first attachment points 314 are shown with a total of eight (8) spread evenly around the sleeve 301. This allows for both a multiple of different positioned the attachable storage 200 can be attached to the protective case 300. Additionally, the attachable storage 200 has the ability to assist in keeping any and all items placed within the sleeve 301 secured. In the depicted embodiment, a first attachment point 314 is shown above the opening to the sleeve 301. Various different configurations of the first attachment points 314 is possible based on the intended purpose and the type of fastener the first attachment point(s) 314 embody. In the depicted embodiment, the first fastener segment 303 is divided into separate segments to allow for the first attachment points 314 to be positioned along the sides of the protective case 300. In the depicted embodiment, there are four (4) segments of the first fastener segments 303. In the depicted embodiment, the first attachment points 314 located along the top edge 309 also assists with keeping the items in the sleeve 309 secure.

The invention is inclusive of combinations of the embodiments or embodiments described herein. References to “a particular embodiment” or “embodiment” and the like refer to features that are present in at least one embodiment of the invention. Separate references to “an embodiment” or “particular embodiments” or “embodiments” or the like do not necessarily refer to the same embodiment or embodiments; however, such embodiments are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention. The present invention shall be easily carried out by an ordinary skilled person in the art, and any modifications and changes are deemed to be within the scope of the present invention.

This written description uses examples to disclose the invention, including the best mode, and also to enable any person skilled in the art to practice embodiments of the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

What is claimed is:

1. A multipurpose protective case for electronic devices comprising:
a housing having a front compartment and a rear surface, wherein the front compartment is sized to securely fit an electronic device;
a piece of elastic material secured to the rear surface of the housing, wherein an accessible space is formed between the rear surface of the housing and the piece of elastic material;
a first plurality of attachment points secured to the rear surface of the housing;
a first plurality of securing means secured to the piece of elastic material; and
a detachable compartment having-a front surface and a rear surface, wherein an opening to a compartment is formed between the front and rear surfaces and the compartment is accessible through an opening, a second plurality of attachment points are secured to the rear surface, wherein the second plurality of attachment points substantially align with the first plurality of attachment points, and a second plurality of securing means, wherein the second plurality of securing means substantially align with the first plurality of securing means.
The multipurpose protective case for electronic devices of claim 1, wherein the second plurality of securing means are rigid.

2. The multipurpose protective case for electronic devices of claim 1, wherein the detachable compartment is a made from a unitary piece of flexible material.

3. The multipurpose protective case for electronic devices of claim 1, wherein the detachable compartment is comprised of a plurality of individual pieces of flexible material, wherein they are secured together.

4. The multipurpose protective case for electronic devices of claim 1, wherein an anti-slip coating is applied to at least one edge of the detachable compartment.

5. The multipurpose protective case for electronic devices of claim 1, wherein the rear surface of the detachable compartment extends a predetermined distance above a top edge of the front surface and a securing means is positioned on the extended portion of the rear surface and the front surface.

6. The multipurpose protective case for electronic devices of claim 1, wherein attachment points are substantially aligned with the securing means.

7. The multipurpose protective case for electronic devices of claim 1, wherein a first, second, and third edge of the detachable compartment have a non-slip coating.

8. The multipurpose protective case for electronic devices of claim 1, wherein the housing further comprises a plurality of openings to allow access to various features of the electronic device.

9. The multipurpose protective case for electronic devices of claim 1, wherein the housing further comprises a first portion secured to a second portion, wherein the second portion is a substantial portion of the rear surface of the housing.

10. The multipurpose protective case for electronic devices of claim 9, wherein the second portion of the housing is made from an elastic material.

11. The multipurpose protective case for electronic devices of claim 1, wherein the securing means is a hook and loop style fastener.

12. The multipurpose protective case for electronic devices of claim 1, wherein the attachment points are magnets.

13. The multipurpose protective case for electronic devices of claim 1, wherein the detachable compartment is flexible.

14. The multipurpose protective case for electronic devices of claim 1, wherein a first side of the detachable compartment is rigid, and a second side of the detachable compartment is flexible.

15. The multipurpose protective case for electronic devices of claim 1, further comprising a rigid insert, wherein the rigid insert is integrated with the detachable compartment.

16. A protective case for electronic devices comprising:
a housing sized to secure to an electronic device and having a rear surface;
a first plurality of attachment points secured to the rear surface of the housing at predetermined locations;
a first plurality of securing means secured to the piece of elastic material positioned relative to the first plurality of attachment points; and
a detachable compartment having a rear surface, wherein a second plurality of attachment points secured to the rear surface and a second plurality of securing means secured to the rear surface in substantially the same position as the first plurality of the attachment points and the securing means.

17. The protective case for electronic devices of claim 16, wherein the detachable compartment edges are coated in an anti-slip coating.

18. The protective case for electronic devices of claim 16, further comprising, a sleeve secured to the rear surface of the housing relative to the first plurality of the attachment points and the securing means.

19. The protective case for electronic devices of claim 17, wherein a first, second, and third edge of the sleeve are secured to the rear surface of the housing, wherein an opening is formed on a fourth edge to an internal compartment.

20. The protective case for electronic devices of claim 19, wherein at least one of the first plurality of attachment points is secured to the rear surface of the housing distal to the fourth edge of the sleeve, wherein when the detachable compartment is secured to the housing, the opening to the internal compartment is not accessible.
